(19) United States
(12) Patent Application Publication
(10) Pub. No.: US 2021/0378381 A1
(43) Pub. Date: Dec. 9, 2021

(54) APPARATUS AND METHODS FOR PLASMA NAIL SURFACE TREATMENT

(71) Applicant: Haigh Industries Inc., Burnaby, British Columbia (CA)

(72) Inventors: Ting-Chen Hsu, Surrey, British Columbia (CA); Sandra Haigh, Burnaby, British Columbia (CA)

(21) Appl. No.: 17/287,363

(22) PCT Filed: Oct. 18, 2019
(86) PCT No.: PCT/CA2019/051484

§ 371 Date: Apr. 21, 2021

Related U.S. Application Data
(60) Provisional application No. 62/778,815, filed on Dec. 12, 2018.
(60) Provisional application No. 62/751,400, filed on Oct. 26, 2018.

(51) Int. Cl. A45D 29/00

(52) U.S. Cl. CPC A45D 29/00; A45D 2200/25; A45D 2200/205

(57) ABSTRACT

The present disclosure relates to treatment of a nail surface with non-thermal (cold) plasma prior to application of an energy cured nail coating. Non-thermal plasma (NTP) generators and electronic components which power and control the NTP generators may be incorporated into a current industry standard UV, LED or combined UV/LED curing lamp to provide a NTP curing lamp. The NTP curing lamp conveniently provides plasma pretreatment and curing of the energy cured nail coating using the same apparatus. Plasma pretreatment of the nail surface prior to application of the energy cured nail coating provides better adhesion of the energy cured nail coating to the nail surface than is achieved without the pretreatment.

### TECHNICAL FIELD

The present disclosure relates to an apparatus and method for plasma nail surface treatment.

### BACKGROUND

Coating nails with an energy cured nail coating is an alternative to using nail lacquer (nail varnish) in the cosmetic industry. Unlike nail lacquer, energy cured nail coatings do not air dry. Instead, and depending on their formulation, energy cured nail coatings are cured under a ultra-violet (UV) or light-emitting diode (LED) curing lamp or a combined UV/LED curing lamp after application onto the nails. Once cured, energy cured nail coatings are generally more wear resistant and durable than nail lacquer and nails coated with an energy cured nail coating may remain un-chipped longer than nails coated with nail lacquer vis-à-vis the same amount of wear.

Standard industry practice for improving adhesion of energy cured nail coatings to the nail surface include physical or chemical etching of the nail surface or addition of chemical adhesive promoters to the energy cured nail coatings to improve the affinity of the energy cured nail coatings to the surface of the nail. Both chemical (acid primers) and physical (buffing) etching of the nail surface change the overall bulk properties of the nail making it thinner and weaker causing irreversible damage. There is a limited selection of chemical adhesion promoters suitable for the cosmetics industry. Furthermore, the concentrations that can be used safely can limit the effectiveness. Nail primers also can often contain VOC's and compounds which may cause allergic reactions.

### SUMMARY

According to a first aspect, there is provided an apparatus comprising:
(a) one or more than one non-thermal plasma (NTP) generator;
(b) a curing lamp selected from the group consisting of LED, UV lamp and a combination thereof;
(c) electronic components to power and control the one or more than one NTP generator and curing lamp; and
(d) a housing enclosing the one or more than one NTP generator, curing lamp and electronic components, the housing configured to receive one or both hands of a user.

According to a second aspect, there is provided an apparatus comprising:
(a) one or more than one non-thermal plasma (NTP) generator;
(b) a curing lamp selected from the group consisting of LED, UV lamp and a combination thereof;
(c) electronic components to power and control the one or more than one NTP generator and curing lamp; and
(d) a housing enclosing the one or more than one NTP generator, curing lamp and electronic components, the housing configured to receive at least the nail portion of one or more digits of one or both hands of a user.

The curing lamp may be a LED/UV curing lamp. The LED/UV curing lamp may emit a wavelength in the range of 350-450 nm.

The apparatus may further comprise one or more than one fan for directing atmospheric air from ambience through plasma discharge onto a nail surface of the one or both hands of the user.

The housing may be configured to receive one or both hands of the user.

According to a third aspect, there is provided an apparatus for pretreating a nail surface of one or more digits of a user's hand prior to application of an energy cured nail coating to the nail surface, the apparatus comprising:
(a) one or more than one non-thermal plasma (NTP) generator;
(b) a housing enclosing the one or more than one NTP generator, the housing configured to receive at least the nail surface of the one or more digits of the user's hand.

The apparatus may further comprise one or more than one fan for directing atmospheric air from ambience through plasma discharge onto the nail surface.

The apparatus may further comprise electronic components to power and control the one or more than one NTP generator.

The apparatus may be configured to be electrically connected to a curing lamp and the curing lamp may be used to power and control the one or more than one NTP generator.

According to another aspect, there is provided a method for application and curing of an energy cured nail coating on a nail surface of a user's hand or hands, the method comprising:
(a) providing the apparatus according to the first aspect;
(b) positioning the user's hand or hands in or under the housing of the apparatus and selecting a plasma setting which turns on the one or more than one NTP generator for plasma treatment of the nail surface for a predetermined period of time;
(c) removing the user's hand or hands from the housing and applying the energy cured nail coating to the nail surface; and
(d) positioning the user's hand or hands in or under the housing of the apparatus and selecting a curing setting which turns on the curing lamp for curing of the energy cured nail coating on the nail surface for a predetermined period of time.

According to another aspect, there is provided a method for application and curing of an energy cured nail coating on a nail surface of a user's hand or hands, the method comprising:
(a) providing the apparatus according to the second aspect;
(b) positioning the one or more digits of one or both hands of the user in or under the housing of the apparatus and selecting a plasma setting which turns on the one or more than one NTP generator for plasma treatment of the nail surface for a predetermined period of time;
(c) removing the user's hand or hands from the housing and applying the energy cured nail coating to the nail surface; and
(d) positioning the one or more digits of one or both hands of the user in or under the housing of the apparatus and selecting a curing setting which turns on the curing lamp for curing of the energy cured nail coating on the nail surface for a predetermined period of time.

The nail surface of all 5 digits of the user's hand or all 10 digits of the user's hands may be treated at the same time using the method.

According to another aspect, there is provided a method of pretreatment of a human nail surface prior to application of an energy cured nail coating comprising directing non-thermal plasma onto the nail surface.

According to another aspect, there is provided a method for application and curing of an energy cured nail coating to a nail surface of a user's hand or hands, the method comprising:
(a) directing non-thermal plasma onto the nail surface for a predetermined period of time;
(b) applying the energy cured nail coating to the nail surface; and
(c) curing the energy cured nail coating on the nail surface for a predetermined period of time using a curing lamp selected from the group consisting of LED, UV lamp and a combination thereof.

According to another aspect, there is provided a kit comprising the apparatus of the first, second or third aspect and one or more than one energy cured nail coating.

According to another aspect, there is provided a kit comprising the apparatus of the first, second or third and instructions for operating the apparatus.

This summary does not necessarily describe the entire scope of all aspects. Other aspects, features and advantages will be apparent to those of ordinary skill in the art upon review of the following description of specific embodiments.

### DETAILED DESCRIPTION

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment.

The present disclosure relates to treatment of a nail surface with non-thermal (cold) plasma prior to application of an energy cured nail coating. By energy cured nail coating it is meant any type of nail coating which requires energy to cure the nail coating on the nail surface such as a gel nail polish. This is in contrast to nail lacquer (nail varnish) which is air dried on the nail surface. Use of the word “energy cured nail coating” throughout this disclosure means one or more than one energy cured nail coating that may be applied to the surface of a nail.

Plasma treatment is a reactive treatment process where positive and negative ions, electrons, and radicals react and collide as long as an electric potential difference exists. The non-thermal plasma treatment may etch the nail surface at the nano scale. Only the very surface of the nail is modified, and it does not affect the bulk properties of the nail. Without wishing to be bound by science, it is thought that combining with increased surface energy caused by the plasma treatment, the energy cured nail coating is drawn into the nail surface via capillary action and adhesion of the energy cured nail coating to the nail surface is improved. Treatment of the nail surface with non-thermal plasma may also add functional groups to the surface of the nail. The components of energy cured nail coatings may be chemically more suitable than regular nail lacquer to have greater interactions with the plasma modified surface. These functional groups may have a higher affinity to the components in energy cured nail coatings compared to a nail lacquer. In addition, the UV functional groups in the energy cured nail coatings may also be able to crosslink with the functional groups formed on the surface of the nail. The addition of functional groups on the nail surface can either eliminate the need for or increase the effectiveness of industry standard chemical adhesion promotors in the energy cured nail coatings.

UV or LED curing lamps or combined UV/LED curing lamps are currently used in the nail industry to initiate polymerization of an energy cured nail coating once it has been applied to the nail surface. Basic components of an industry known LED or UV/LED curing lamp include LEDs which emit wavelength in the range of 350-450 nm, electronic components to power and control the LEDs, and a housing in which one or both hands are placed during curing of the energy cured nail coating. Industry standard UV curing lamps are similar, however they include a UV lamp instead of LEDs.

In one embodiment, one or more non-thermal plasma (NTP) generators and electronic components which power and control the NTP generators are incorporated into a UV, LED or combined UV/LED curing lamp (hereinafter referred to as “curing lamp”) to provide a NTP curing lamp. Non-thermal plasma may be generated using different technology known in the art such as arc discharge, corona discharge, dielectric barrier discharge, piezoelectric direct discharge and the like and one or more of these technologies can be incorporated in the NTP curing lamp. Atmospheric air may be directed from ambience through plasma discharge onto the nail surface by fans. Plasma activation is achieved when the charged particles collide with the nail surface.

In one embodiment, prior to application of an energy cured nail coating to the nail surface, one or both hands of a user are placed into or under the NTP curing lamp. The plasma setting is selected, and the non-thermal plasma treatment is applied to the nail surface of one or both hands for a set period. The hand(s) is then removed from the apparatus and the energy cured nail coating is applied to the surface of the nails. The hand(s) is then placed back into the NTP curing lamp and the curing setting is selected for industry standard curing of the energy cured nail coating.

The NTP generators may therefore be incorporated into an already necessary curing lamp that beneficially provides the convenience and simplicity of only needing one device to perform the pre-treatment as well as the curing of energy cured nail coatings. The NTP curing lamp may be able to treat and cure the nails on one or both hands at the same time increasing the efficiency of the process.

In another embodiment the NTP curing lamp may be configured to receive one or more digits of a hand rather than the whole hand. For example the NTP curing lamp may be a chamber which receives at least the nail portion of one or more digits. In use, the NTP curing lamp is able to pretreat one or more nail at a time with non-thermal plasma as well as cure the energy cured nail coating once it has been applied to the nails.

In another embodiment, one or more non-thermal plasma (NTP) generators are incorporated into a housing. Electronic components that power and control the NTP generator(s) may also be incorporated into the housing and/or the housing may be configured to electrically connect to a curing lamp and the curing lamp may be used to power and control the NTP generator(s). The housing is configured to receive one or more than one digit of a hand. The housing receives at least the nail portion of the one or more digits. In a preferred embodiment, the housing is configured to receive the nail portion of one digit at a time. For example, the housing may be a chamber which receives and surrounds the nail portion of the digit and is able to pretreat the nail surface with plasma. The device is used to pretreat nails before an energy cured nail coating is applied to the nails. Atmospheric air may be directed from ambience through plasma discharge onto the nail surface by fans. As discussed above in more details, plasma activation is achieved when the charged particles collide with the nail surface.

The present embodiments also relate to a method of treating a nail surface with plasma prior to application of an energy cured nail coating. As discussed above, pretreating the nail surface with plasma may result in better adhesion of the energy cured nail coating to the surface of the nail than is achieved without the pretreatment.

It is contemplated that any part of any aspect or embodiment discussed in this specification can be implemented or combined with any part of any other aspect or embodiment discussed in this specification. While particular embodiments have been described in the foregoing, it is to be understood that other embodiments are possible and are intended to be included herein. It will be clear to any person skilled in the art that modification of and adjustment to the foregoing embodiments, not shown, is possible.

1. An apparatus comprising:
(a) one or more than one non-thermal plasma (NTP) generator;
(b) a curing lamp selected from the group consisting of LED, UV lamp and a combination thereof;
(c) electronic components to power and control the one or more than one NTP generator and curing lamp; and
(d) a housing enclosing the one or more than one NTP generator, curing lamp and electronic components, the housing configured to receive a nail surface of a user.

2. The apparatus according to claim 1, wherein the curing lamp is a LED/UV curing lamp.

3. The apparatus according to claim 2, wherein the LED/UV curing lamp emits a wavelength in the range of 350-450 nm.

4. The apparatus according to claim 1 further comprising one or more than one fan for directing atmospheric air from ambience through plasma discharge onto the nail surface.

5. The apparatus according to claim 1, wherein the housing is configured to receive the nail surface of one or both hands of the user.

6. A method for application and curing of an energy cured nail coating on a nail surface, the method comprising:
(a) providing the apparatus according to claim 1;
(b) positioning the nail surface in or under the housing of the apparatus and selecting a plasma setting which turns on the one or more than one NTP generator for plasma treatment of the nail surface for a predetermined period of time;
(c) removing the nail surface from the housing and applying the energy cured nail coating to the nail surface; and
(d) positioning the nail surface in or under the housing of the apparatus and selecting a curing setting which turns on the curing lamp for curing of the energy cured nail coating on the nail surface for a predetermined period of time.

7. The method of claim 6, wherein the nail surface of all 5 digits of a user's hand or all 10 digits of the user's hands are treated at the same time using the method.

8. A method of pretreatment of a human nail surface prior to application of an energy cured nail coating comprising directing non-thermal plasma onto the nail surface.

9. A method for application and curing of an energy cured nail coating to a nail surface, the method comprising:
(a) directing non-thermal plasma onto the nail surface for a predetermined period of time;
(b) applying the energy cured nail coating to the nail surface; and
(c) curing the energy cured nail coating on the nail surface for a predetermined period of time using a curing lamp selected from the group consisting of LED, UV lamp and a combination thereof.

10. An apparatus for pretreating a nail surface prior to application of an energy cured nail coating to the nail surface, the apparatus comprising:
(a) one or more than one non-thermal plasma (NTP) generator;
(b) a housing enclosing the one or more than one NTP generator, the housing configured to receive the nail surface.

11. The apparatus according to claim 10 further comprising one or more than one fan for directing atmospheric air from ambience through plasma discharge onto the nail surface.

12. The apparatus according to claim 10 further comprising electronic components to power and control the one or more than one NTP generator.

13. The apparatus according to claim 10, wherein the apparatus is configured to be electrically connected to a curing lamp and the curing lamp is used to power and control the one or more than one NTP generator.

14. A kit comprising the apparatus of claim 1 and one or more than one energy cured nail coating.

15. A kit comprising the apparatus of claim 1 and instructions for operating the apparatus.

16. The apparatus according to claim 1, wherein the housing is configured to receive the nail surface of one or both feet of the user.

17. The method of claim 6, wherein the nail surface of all 5 digits of a user's foot or all 10 digits of the user's feet are treated at the same time using the method.

18. The apparatus according to claim 10, wherein the housing is configured to receive the nail surface of one or both hands of a user.

19. The apparatus according to claim 10, wherein the housing is configured to receive the nail surface of one or both feet of a user.
